(19) United States
(12) Patent Application Publication
(10) Pub. No.: US 2025/0230749 A1
(43) Pub. Date: Jul. 17, 2025

(54) ARTIFICIAL INTELLIGENCE-BASED METHOD FOR IDENTIFYING LOCATIONS OF WATER INRUSH POINTS IN MINE

(71) Applicants: Xuzhou High Tech Zone Safety Emergency Equipment Industrial Technology Research Institute, Xuzhou (CN); China University of Mining and Technology, Xuzhou (CN)

(72) Inventors: Junjun CHEN, Xuzhou (CN); Lei MENG, Xuzhou (CN); Peng LIU, Xuzhou (CN); Zhengzheng TANG, Xuzhou (CN); Peng LIU, Xuzhou (CN)

(21) Appl. No.: 19/022,198

(22) Filed: Jan. 15, 2025

Related U.S. Application Data
(63) Continuation of application No. PCT/CN2024/095080, filed on May 24, 2024.

(30) Foreign Application Priority Data
Jan. 11, 2024 (CN) 202410045759.5

(51) Int. Cl. E21F 17/00; G06F 30/27; G06F 30/28; G06F 111/10; G06F 113/08

(52) U.S. Cl. CPC E21F 17/00; G06F 30/27; G06F 30/28; G06F 2111/10; G06F 2113/08

(57) ABSTRACT

The present disclosure provides an artificial intelligence-based method for enhancing mine safety by identifying and predicting locations of water inrush points in a mine, including the following steps: S1: constructing a numerical model to determine priori information of parameters to be recognized based on observation data, including coordinates of locations of water inrush points; S2: generating a training sample dataset and a test sample dataset of an alternative model based on the numerical model and the priori information of the parameters; S3: constructing and training a neural network of the alternative model; S4: testing an accuracy of the alternative model; and S5: performing a simulated annealing algorithm to identify the locations of water inrush points and simulation model parameters.

### CROSS-REFERENCE TO RELATED APPLICATIONS

This application is a continuation of PCT/CN2024/095080, filed May 24, 2024 and claims priority of Chinese Patent Application No. 202410045759.5, filed on Jan. 11, 2024, the entire contents of which are incorporated herein by reference.

### TECHNICAL FIELD

The present disclosure relates to coal mine water inrush disaster prevention and control, and particularly relates to an artificial intelligence-based method for identifying locations of water inrush points in a mine and simulation model parameters.

### BACKGROUND

With the increasing depth of coal mining, the hydrogeological conditions become more and more complicated, and sudden water disasters in coal mines occur from time to time, and causes serious casualties and property losses. Groundwater stored in the aquifer is the main source of water in the mine, and the coal mining activity causes the destruction of rock strata and thus formation a water channel, so that the water in the aquifer surges into the mine laneway in large quantities in a short period of time, and further leads to serious consequences such as flooding of mines, trapping of personnel, and destruction of production equipment. In order to effectively carry out the rescue work for water inrush in mine and to avoid the occurrence of secondary accidents, it is not only required to quickly clarify the specific locations of the water inrush points in the mine, but also required to clarify the key model parameters involved in carrying out the simulation and prediction of the water inrush, so as to accurately analyze the scope of the flooding of the mine. It plays an important role for the development of the rescue and prevention program.

Currently, it mainly relies on underground workers to report the locations of the water inrush points to the dispatching office via underground telephone after water inrush, but the reported locations are often regional locations without accurate location coordinates, and it is impossible to know the locations of the water inrush points if the water inrush results in damage to the communication equipment in mine or the personnel being trapped and unable to contact with the personnel on the ground. The water source identification method proposed by the existing research is to collect water samples after the water inrush, analyze the water chemistry data, and identify which aquifer the water inrush comes from by using the algorithms such as cluster analysis or support vector machine according to the water quality characteristics of different water sources. However, this method cannot locate the coordinates of the water inrush points. In addition, the values of the numerical model parameters involved in the simulation and prediction of water inrush will directly determine the reliability of the simulation and prediction results. However, in most cases, many of the parameters of the numerical groundwater-flow model cannot be obtained directly by the existing measurement means.

Inverse simulation is to identify the model parameters that are difficult to obtain directly in reverse by using the observation data that may be obtained in the system based on the construction of the forward numerical model. At present, the main scheme for inverse simulation is to transform the research problem into an optimization problem and solve it by an optimization-seeking method. For this technical field, the research problem may be transformed into a parameter optimization problem according to the nonlinear optimization theory, and the artificial intelligence method combining deep learning and simulated annealing algorithm is comprehensively used to realize efficient and accurate solution of the optimization problem, so as to simultaneously identify the locations of the water inrush points in the mine and the simulation model parameters.

### SUMMARY

An objective of the disclosure is to provide an artificial intelligence-based method for identifying locations of water inrush points in a mine and simulation model parameters, and the method is capable of determining coordinates of spatial locations of the water inrush points in the mine and rapidly and simultaneously identifying the locations of the water inrush points in the mine and the simulation model parameters.

In order to achieve the above objective, the present disclosure provides an artificial intelligence-based method for identifying locations of water inrush points in a mine and simulation model parameters. The general idea is to construct a numerical groundwater-flow model in an aquifer with water inrush in the mine, and then according to the water level decline data obtained from the known groundwater level observation wells in this aquifer, the locations of the water inrush points, together with other unknown parameters such as permeability rate and water inrush quantity, are taken as the decision variables and a nonlinear optimization model is constructed; the locations of the water inrush points, permeability rate and water inrush quantity and other unknown parameters of the model are simultaneously identified by solving the nonlinear optimization model based on the simulated annealing algorithm. In this process, in order to ensure the computational efficiency of the optimization process, an alternative model modeling method based on deep learning will also be used. Specific, the artificial intelligence-based method for identifying locations of water inrush points in a mine and simulation model parameters includes the following steps:
S1: constructing a numerical groundwater-flow model in an aquifer with water inrush in the mine, and setting up water level simulation results to output the water inrush points according to locations of actual hydrological observation wells and observation time in the numerical groundwater-flow model; taking a horizontal coordinate x and a vertical coordinate y of locations of the water inrush points, a water inrush quantity Q and n unknown parameters (p₁, . . . , pₙ denote the n unknown parameters in the numerical groundwater-flow model) as decision variables m=[X, Y, Q, p₁, . . . , pₙ]; moreover, determining a range of values of each of the decision variables in m based on collected prior information, and denoting an upper limit and a lower limit of the values of the decision variables as m_{U}=[X_{U}, Y_{U}, Q_{U}, p_{1U}, . . . , p_{nU}] and m_{L}=[X_{L}, Y_{L}, Q_{L}, p_{1L}, . . . , p_{nL}], respectively;
S2: according to the upper limit m_{U} and the lower limit m_{L} of the decision variables, randomly sampling the numerical groundwater-flow model to obtain two sets of parameter datasets by using a Latin hypercube sampling method, and using the two sets of the parameter datasets as input parameters of a training sample dataset M_{Train}[m_{Train(1)}, . . . , m_{Train(n}_{_{Train}}₎] and input parameters of a test sample dataset M_{Test}[m_{Test(1)} . . . , m_{Test(n}_{_{Test}}₎]; calculating water level simulation results at the observation time at the hydrological observation wells corresponding to each of the samples of the model parameter in M_{Train} and M_{Test}, storing all observation data in a vector data format yᵢ, and finally obtaining model response results Y_{Train}=[y_{Train(1)} . . . , y_{Train(n}_{_{Train}}₎] for the training sample dataset and model response results Y_{Test}=[y_{Test(1)} . . . y_{Test(n}_{_{Test}}₎] for the test sample dataset, wherein the training sample dataset and the test sample dataset are represented as D_{Train}={M_{Train}, Y_{Train}} and D_{Test}={M_{Test}, Y_{Test}}, respectively;
S3: constructing and training a deep convolutional neural network (DNN model), wherein an input layer and an output layer of the DNN model are a parameter vector mᵢ of the numerical groundwater-flow model and a model response vector yᵢ, respectively; representing the DNN model as ŷᵢ=F_{DNN}(mᵢ,θ_{DNN}); constructing a deep convolutional neural network based on constraints of L1 norm to realize a loss function of prediction of an alternative model, and then with a target of minimizing the loss function, updating θ_{DNN} to complete training of the DNN model and then to obtain a trained DNN model; and taking the trained DNN model F_{DNN}(mᵢ,θ_{DNN}) as an alternative model to the numerical groundwater-flow model in S1;
S4: substituting the input parameters M_{Test} from the test sample dataset D_{Test} obtained in S2 into the alternative model F_{DNN}(mᵢ,θ_{DNN}) item by item to obtain corresponding prediction results Ŷ_{Test}[ŷ_{Test(1)} . . . ŷ_{Test(n}_{_{Test}}₎]; judging whether a prediction accuracy of the alternative model meets requirements based on values of the converged loss function L trained by F_{DNN}(mᵢ,θ_{DNN}) and values of a certainty coefficient R² obtained by computing Y_{Test} and Ŷ_{Test}; performing S5, if the prediction accuracy meets the requirements; otherwise, returning to S2 to increase a number of the samples of the training sample dataset; and
S5: solving the nonlinear optimization inversion model using the trained DNN model F_{DNN} (mᵢ,θ_{DNN}) that meets the accuracy requirements in S4 as an equation constraint, taking the upper limit m_{U} and lower limit m_{L} of the overall of the decision variables m in S1 as inequality constraints, and combining them with the least squares constraints to construct a nonlinear optimization inversion model used as the constraints of the overall of the decision variables m=[X, Y, Q, p₁, . . . , pₙ] in S1; and then optimally solving the overall of the decision variables m by using the simulated annealing algorithm to find the optimal solution of the overall of decision variables m under the constraints of the nonlinear optimization inversion model constructed in this step, so as to ultimately obtain the coordinates X and Y of the locations of the water inrush points, as well as the other simulation prediction key parameters, Q and pᵢ.

In S1, the numerical groundwater-flow model in the aquifer with water inrush in the mine is constructed by using a numerical groundwater-flow simulation software TOUGHREACT. The water inrush quantity Q is generalized to a constant value, and n other unknown model parameters represent the permeability values of the n permeability parameter partitions in the simulated area.

According to the upper limit m_{U} and the lower limit m_{L} of the decision variables in S1, the Latin hypercube sampling method is used to sample in S2, and follows a principle of uniformly distributed sampling.

In S2, the number of samples n_{Train} is greater than a number of the samples n_{Test}, and the number of the samples n_{Test} greater than or equal to 50.

A deep residual two-dimensional convolutional neural network of the ResNet-18 is improved to obtain the DNN model in S3, including firstly mapping and outputting vector data input to the decision variables as a 6400-dimensional vector by using a fully connected neural network, and then reshaping the 6400-dimensional vector as an 80×80 rectangular data structure used as the input layer of the ResNet-18, wherein the output layer is a vector with a dimension consistent with observation data y.

In S3, a calculation formula for constructing the deep convolutional neural network based on the constraints of the L1 norm to realize the loss function of the alternative model prediction is as follows:

$${θ}_{DNN} = arg min \frac{1}{N} {\sum }_{i = 1}^{N} \vert {F}_{DNN} ( {m}_{i} , {θ}_{DNN} ) - {y}_{i} \vert + \frac{{w}_{d}}{2} {θ}_{DNN}^{T} {θ}_{DNN} , \qquad ( 1 )$$

wherein θ_{DNN} denotes a weight parameter of the deep neural network; mᵢ and yᵢ denote a model parameter and model output of i-th group of the samples in the training sample dataset, respectively; N denotes a total number of the samples in the training sample dataset; and w_{d} denotes a regularization term during the training of neural network, and is used to prevent the training from overfitting.

In S3, θ_{DNN} is updated with the target of minimizing the loss function in formula (1) by using a deep learning framework pytorch.

In S4, a formula for calculating the certainty coefficient R² is as follows:

$${R}^{2} = 1 - \frac{{\sum }_{i = 1}^{M} {‖ {y}_{Test ( i )} - {\hat{y}}_{Test ( i )} ‖}_{2}^{2}}{{\sum }_{i = 1}^{M} {‖ {y}_{Test ( i )} - \overline{y} ‖}_{2}^{2}} , \qquad ( 2 )$$

wherein y̅ denotes a mean of all y_{Train(i)}.

In S4, the smaller the values of the converged loss function L is and the closer the values of the certainty coefficient R² is to 1, the higher the prediction accuracy of the alternative model F_{DNN}(mᵢ,θ_{DNN}) is; in the disclosure, a threshold of the loss function L₀ and a threshold of the certainty coefficient R₀² is set in advance; and then it is determined if the prediction accuracy of the alternative model satisfies the accuracy requirements by judging whether L is less than or equal to L₀ and R² is greater than or equal to R₀².

In S5, a basic form of the nonlinear optimization inversion model is as follows:

$$\begin{matrix}F = min {\sum }_{i = 1}^{{N}_{obs}} {[ {y}_{obs} [ i ] - \hat{y} [ i ] ]}^{2} \\ \{ \begin{matrix}\hat{y} = {F}_{DNN} ( {m}_{i} , {θ}_{DNN} ) \\ {m}_{U} \leq m \leq {m}_{L}\end{matrix}\end{matrix} , \qquad ( 3 )$$

where F denotes an objective function based on the least squares constraint; y_{obs} denotes a vector of the observation data; y_{obs}[i] denotes i-th variable element in the vector of the observation data; m_{L} and m_{U} denote the upper limit vector and lower limit vector of the model parameter vector m, respectively; and N_{obs} denotes a number of the observation data.

In S5, the simulated annealing algorithm is performed in the following steps:
S501: setting a hyperparameter initial iteration temperature T₀ of the simulated annealing algorithm and an initial solution mᵢ of the decision variables m;
S502: generating a new solution mᵢ randomly in neighborhood of mᵢ by multiplying mᵢ by a random disturbance coefficient e(mⱼ=e*mᵢ), wherein e is a random number of dimension consistent with m randomly generated according to a Gaussian distribution N˜(1,σ²), wherein σ takes a value of 0.01 by default, and the value of σ may be adjusted in different application scenarios with an adjustment range of 0-0.1;
S503: calculating mᵢ and mⱼ by substituting into formula (3), respectively, to obtain values of an inverse optimization objective function corresponding to mᵢ and mⱼ: Fᵢ and Fⱼ;
S504: updating a current solution mᵢ to mⱼ, if Fᵢ is greater than or equal to Fⱼ; otherwise, calculating a probability of updating mᵢ to mⱼ according to a following formula:

$$P ( {m}_{i} →︀ {m}_{j} = exp ( \frac{{F}_{i} - {F}_{j}}{{a}^{t} {T}_{0}} ) , \qquad ( 4 )$$

where α denotes an attenuation coefficient in the simulated annealing algorithm, and takes a value of 0.99; t denotes current time, and indicates the current number of loop iterations;
specific, the probability in formula (4) is judged by generating a random number rand(x) between 0 and 1, and when rand(x) is less than or equal to P(mᵢ→mⱼ), then mᵢ is updated to mⱼ; otherwise, mᵢ is not updated;
S505: repeating S502 to S504 under current temperature conditions until a preset number of inner loop iterations in the simulated annealing algorithm is reached; then updating the temperature and the time: t=t+1 and Tᵢ-a′T₀, respectively;
S506: returning S502 and updating Tt and t obtained in S505 until a preset number of the outer loop iterations is reached.

The disclosure has the following effects.

The present disclosure proposes an artificial intelligence-based method for identifying locations of water inrush points in a mine and simulation model parameters based on groundwater inversion theory. The technical method integrates the alternative model method based on deep learning and the parameter optimization strategy based on simulated annealing algorithm, and may make use of the water level change monitoring data that may be directly obtained at the site, and further may synchronously identify the specific locations of the water inrush points that is difficult to be directly obtained as well as the key parameters of the simulation model, and thus may provide technical support for the rescue of the water inrush disaster of the mine and the accurate simulation of the scope of the disaster impact.

### BRIEF DESCRIPTION OF THE DRAWINGS

The present disclosure is further described below in connection with the drawings and embodiments.

FIG. 1 shows a flowchart of a method flow chart of an artificial intelligence-based method for identifying locations of water inrush points in a mine and simulation model parameters of the present disclosure.

FIG. 2 shows a schematic diagram of a simulation area model of an embodiment of the present disclosure.

FIG. 3A shows a comparison between the simulation results of the water level difference of the correction model and the actual observation results at the observation well #1.

FIG. 3B shows a comparison between the simulation results of the water level difference of the correction model and the actual observation results at the observation well #2.

FIG. 3C shows a comparison between the simulation results of the water level difference of the correction model and the actual observation results at the observation well #3.

FIG. 3D shows a comparison between the simulation results of the water level difference of the correction model and the actual observation results at the observation well #4.

FIG. 3E shows a comparison between the simulation results of the water level difference of the correction model and the actual observation results at the observation well #5.

FIG. 3F shows a comparison between the simulation results of the water level difference of the correction model and the actual observation results at the observation well #6.

FIG. 3G shows a comparison between the simulation results of the water level difference of the correction model and the actual observation results at the observation well #7.

FIG. 3H shows a comparison between the simulation results of the water level difference of the correction model and the actual observation results at the observation well #8.

FIG. 3I shows a comparison between the simulation results of the water level difference of the correction model and the actual observation results at the observation well #9.

FIG. 3J shows a comparison between the simulation results of the water level difference of the correction model and the actual observation results at the observation well #10.

FIG. 4 shows a schematic diagram of the structure of the DNN model generated on the basis of the ResNet-18 model results of the present disclosure.

### DETAILED DESCRIPTION OF THE EMBODIMENTS

The method of the present disclosure will be described in detail with specific examples.

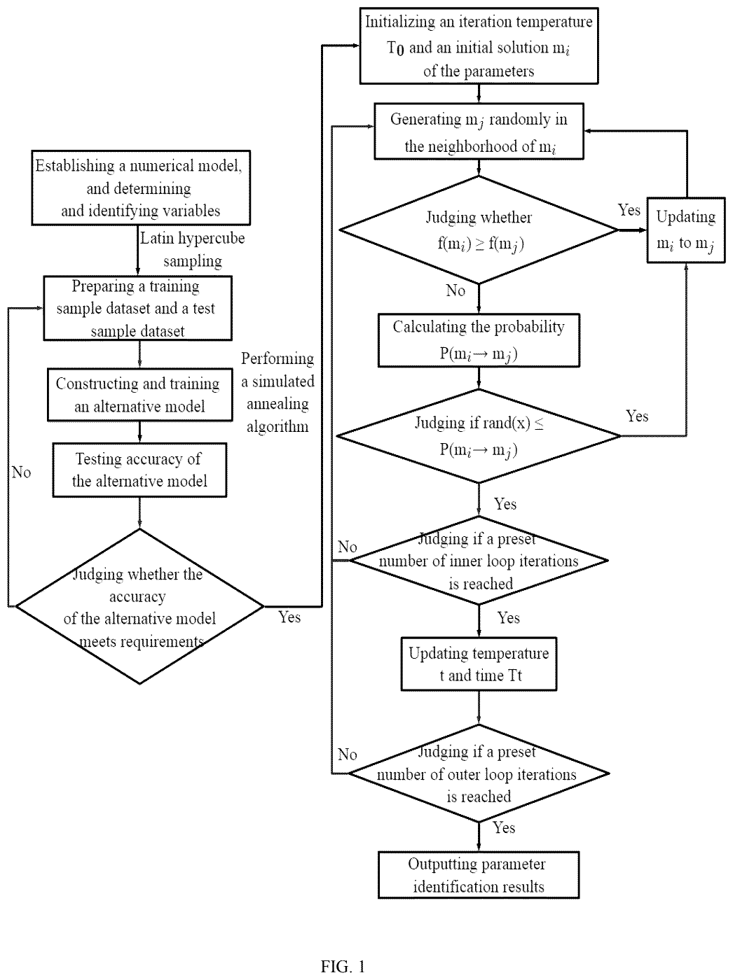

As shown in FIG. 1, an artificial intelligence-based method for identifying locations of water inrush points in a mine and simulation model parameters including the following steps.

S1: Based on the basic data of hydrogeological conditions in the mine area, constructing a numerical groundwater-flow model in the aquifer with water inrush in the mine area, where in the numerical groundwater-flow model in the aquifer with water inrush in the mine area, there are hydrological observation wells used to study the changes of water level, and the hydrological observation wells are defined as the water level observation points; preliminarily determining the range of coordinates of water inrush points, the water inrush quantity and the range of a priori intervals of other unknown parameters of the numerical groundwater-flow model in the aquifer with water inrush in the mine area based on the mining engineering plan;
the horizontal coordinate x and vertical coordinate y of the locations of the unknown water inrush points, the water inrush quantity Q and n unknown parameters are taken as the decision variables, where the overall of decision variables m=[X, Y, Q, p₁, . . . , pₙ], p₁, . . . , pₙ denote the n unknown parameters in the numerical groundwater-flow model, including the permeability parameters of the different subareas and the boundary condition parameters; moreover, the range of values of each of the decision variables in m is determined based on the collected prior information, and the upper limit and lower limit of values of the decision variables are denoted as m_{U}=[X_{U}, Y_{U}, Q_{U}, p_{1U}, . . . , p_{nU}] and M_{L}=[X_{L}, Y_{L}, Q_{L}, p_{1L}, . . . , p_{nL}], respectively.

S2: According to the determined upper limit m_{U} and lower limit m_{L} of the decision variables, randomly sampling the numerical groundwater-flow model to obtain two sets of parameter datasets by using the Latin hypercube sampling method, where the two sets of parameter datasets are used as the input parameters of the training sample dataset M_{Train}=[m_{Train(1)}, . . . , m_{Train(n}_{_{Train}}₎] and the input parameters of the test sample dataset M_{Test}=[m_{Test(1)}, . . . , m_{Test(n}_{_{Test}}₎], where n_{Train} denotes the samples of the training sample dataset M_{Train} and n_{Test} denotes the samples of the test sample dataset M_{Test};
calculating the water level simulation results at the observation time at the hydrological observation wells corresponding to each model parameter sample in M_{Train} and M_{Test} by using the numerical groundwater-flow model, storing all observation data in vector data format yᵢ, and finally obtaining model response results Y_{Train}=[y_{Train(1)}, . . . , y_{Train(n}_{_{Train}}₎] for the training sample dataset and model response results Y_{Test}=[y_{Test(1)}, . . . , y_{Test(n}_{_{Test}}₎] for the test sample dataset, where the training sample dataset and the test sample dataset are represented as D_{Train}={M_{Train}, Y_{Train}} and D_{Test}={M_{Test}, Y_{Test}}, respectively;
the decision variables take the upper limit of m_{U} and the lower limit of m_{L}; the Latin hypercube sampling method is used to sample, and follows the principle of uniformly distributed sampling; the number of samples n_{Train} is greater than the number of samples n_{Test}, and the number of samples n_{Test} greater than or equal to 50.

S3: Constructing a deep convolutional neural network (DNN model), where the input layer and the output layer of the DNN model are the parameter vector mᵢ of the numerical groundwater-flow model and the model response vector yᵢ, respectively, and the DNN model is represented as ŷᵢ=F_{DNN} (mᵢ,θ_{DNN}), where θ_{DNN} denotes the weight parameter of the deep neural network; constructing a deep convolutional neural network based on the constraints of the L1 norm to realize the loss function of the alternative model prediction of the numerical groundwater-flow model, and then with the target of minimizing the loss function, updating the θ_{DNN} by the error back-propagation algorithm to complete the training of DNN model; moreover, taking the trained DNN model F_{DNN} (mᵢ,θ_{DNN}) as an alternative model to the numerical groundwater-flow model in S1;
the calculation formula for constructing the deep convolutional neural network based on the constraints of the L1 norm to realize the loss function of the alternative model prediction is as follows:

$${θ}_{DNN} = arg min \frac{1}{N} {\sum }_{i = 1}^{N} \vert {F}_{DNN} ( {m}_{i} , {θ}_{DNN} ) - {y}_{i} \vert + \frac{{w}_{d}}{2} {θ}_{DNN}^{T} {θ}_{DNN} , \qquad ( 1 )$$

where θ_{DNN} denotes the weight parameter of the deep neural network; mᵢ and yᵢ denote the model parameter and model output of the i-th group of samples in the training sample dataset, respectively; N denotes the total number of samples in the training sample dataset; and w_{d} denotes the regularization term during the training of neural network, and is used to prevent the training from overfitting.

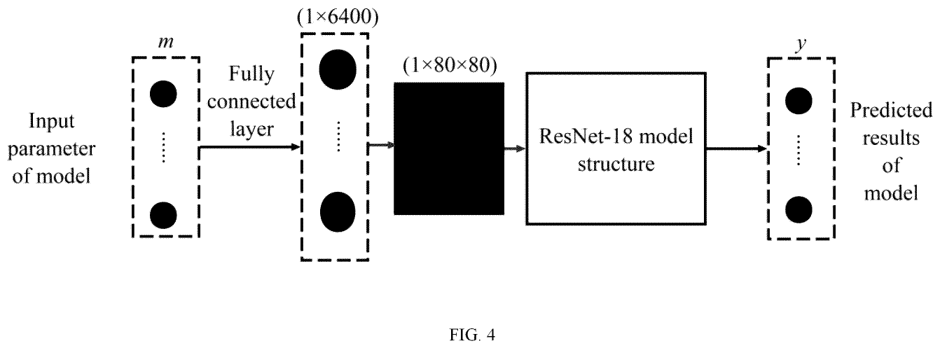

FIG. 4 shows the schematic structure of the DNN model built by alternative modeling based on the results of the ResNet-18 model: the deep residual two-dimensional convolutional neural network of ResNet-18 is improved to obtain the DNN model, including firstly mapping and outputting the vector data input to the decision variables as a 6400-dimensional vector by using a fully connected neural network, and then reshaping the 6400-dimensional vector as an 80×80 rectangular data structure used as the input layer of ResNet-18, where the output layer is a vector whose dimension is consistent with the observation data y, and all others are the original structure of ResNet-18.

S4: Substituting the input parameters M_{Test} from the test sample dataset D_{Test} obtained in S2 into the alternative model F_{DNN}(mᵢ,θ_{DNN}) item by item to obtain the corresponding prediction results Ŷ_{Test}=[ŷ_{Test(1)}], . . . , ŷ_{Test(n}_{_{Test}}₎; judging whether the prediction accuracy of the alternative model meets the requirements based on the values of the converged loss function L trained by the F_{DNN}(mᵢ,θ_{DNN}) and the values of the certainty coefficient R² obtained by computing the Y_{Test} and the Ŷ_{Test}; performing S5, if the prediction accuracy meets the requirements; otherwise, returning to S2 to increase the number of samples of the training sample dataset; the smaller the value of the converged loss function L is and the closer the value of the certainty coefficient R² is to 1, the higher the prediction accuracy of the alternative model F_{DNN}(mᵢ,θ_{DNN}) is; in the present disclosure, setting a threshold of the loss function L₀ and a threshold of the certainty coefficient R₀² in advance; and determining if the prediction accuracy of the alternative model satisfies the accuracy requirements by judging whether L is less than or equal to L₀ and R² is greater than or equal to R₀².

The formula for calculating the certainty coefficient R² is as follows:

$${R}^{2} = 1 - \frac{{\sum }_{i = 1}^{M} {‖ {y}_{Test ( i )} - {\hat{y}}_{Test ( i )} ‖}_{2}^{2}}{{\sum }_{i = 1}^{M} {‖ {y}_{Test ( i )} - \overline{y} ‖}_{2}^{2}} , \qquad ( 2 )$$

where y̅ denotes the mean of all y_{Train(i)}.

S5: Taking the alternative model F_{DNN}(mᵢ,θ_{DNN}) that meets the accuracy requirements in S4 as an equation constraint, taking the upper limit m_{U} and lower limit m_{L} of the overall of the decision variables m in S1 as inequality constraints, and combining them with the least squares constraints to construct a nonlinear optimization inversion model used as the constraints of the overall of the decision variables m=[X, Y, Q, p₁, . . . , pₙ] in S1; and then optimally solving the overall of the decision variables m by using the simulated annealing algorithm to find the optimal solution of the overall of decision variables m under the constraints of the nonlinear optimization inversion model constructed in this step, so as to ultimately obtain the coordinates X and Y of the locations of the water inrush points, as well as the other simulation prediction key parameters, Q and p₁, . . . , pₙ.

The basic form of the nonlinear optimization inversion model is as follows:

$$\begin{matrix}F = min {\sum }_{i = 1}^{{N}_{obs}} {[ {y}_{obs} [ i ] - \hat{y} [ i ] ]}^{2} \\ \{ \begin{matrix}\hat{y} = {F}_{DNN} ( {m}_{i} , {θ}_{DNN} ) \\ {m}_{U} \leq m \leq {m}_{L}\end{matrix}\end{matrix} , \qquad ( 3 )$$

where F denotes the objective function based on the least squares constraint; y_{obs} denotes the observation data vector; y_{obs}[i] denotes the i-th variable element in the observation data vector; m_{L} and m_{U} denote the upper limit and lower limit vectors of the model parameter vector m, respectively; and N_{obs} denotes the number of observation data.

The simulated annealing algorithm is performed in the following steps:
S501: setting the hyperparameter initial iteration temperature T₀ of the simulated annealing algorithm and the initial solution mᵢ of the decision variables m;
S502: generating a new solution mⱼ randomly in the neighborhood of mᵢ by multiplying mᵢ by a random disturbance coefficient e(mⱼ=e*mᵢ), where e is a random number of dimension consistent with m randomly generated according to a Gaussian distribution N˜(1,σ²), where σ takes the value of 0.01 by default, and the value of σ may be adjusted in different application scenarios with the adjustment range of 0-0.1;
S503: calculating mᵢ and mⱼ by substituting them into formula (3), respectively, to obtain the values of the inverse optimization objective function corresponding to mᵢ and mⱼ: Fᵢ and Fⱼ;
S504: updating the current solution mᵢ to mⱼ, if Fᵢ is greater than or equal to Fⱼ; otherwise, calculating the probability of updating mᵢ to mⱼ according to the following formula:

$$P ( {m}_{i} →︀ {m}_{j} = exp ( \frac{{F}_{i} - {F}_{j}}{{a}^{t} {T}_{0}} ) , \qquad ( 4 )$$

where α denotes the attenuation coefficient in the simulated annealing algorithm, and takes the value of 0.99; t denotes the current time, and indicates the current number of loop iterations; T₀ denotes the temperature at the moment of the initial iteration, and takes the value of 100 by default; probability in formula (4) is judged by generating the random number rand(x) between 0 and 1, and when rand(x) is less than or equal to P(mᵢ→mⱼ), then mᵢ is updated to mⱼ; otherwise, it is not updated;
S505: repeating S502 to S504 under the current temperature conditions until the preset number of inner loop iterations in the simulated annealing algorithm is reached; then updating the temperature and time: t=t+1 and Tₜ=a^{t}T₀, respectively;
S506: returning S502 and updating Tt and t obtained in S505 until the preset number of the outer loop iterations is executed.

### EMBODIMENT

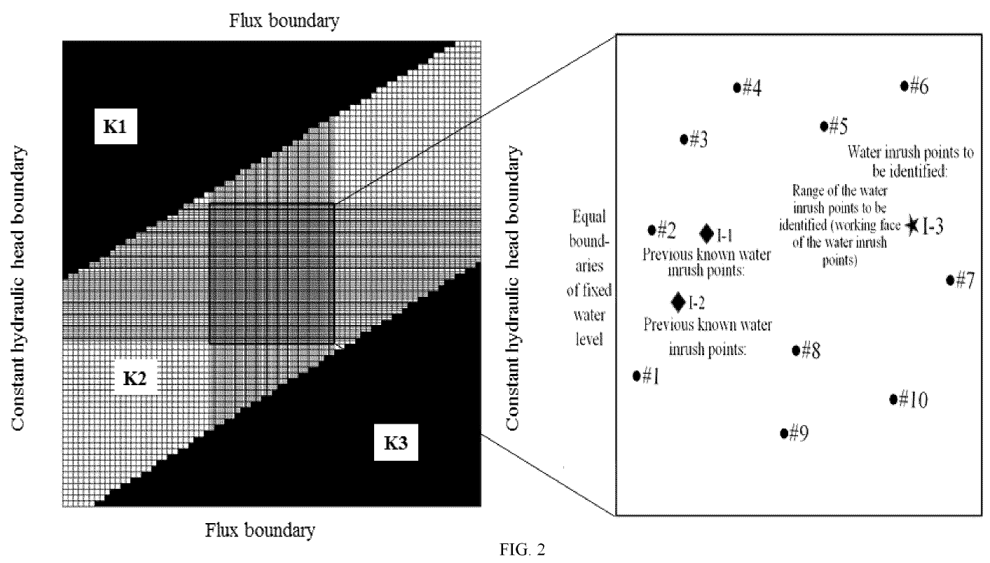

A scenario of water inrush in coal mine is constructed. The specific water inrush aquifer has been clarified, and the specific location of the water inrush points need to be further determined. A two-dimensional groundwater-flow model is obtained using TOUGHREACT modeling. The model extent is 10,000 m×10,000 m, with the east and west boundaries assumed to be equal boundaries of fixed water level and the north and south boundaries of zero flow. There are two known water inrush points in the study area, and the water inrush quantities are 72 m³/h at point I1 and 54 m³/h at point I2. It is assumed that water inrush occurs at a certain working face, but the locations of the water inrush points is unknown; when the model is run to 360 days, the water inrush occurs, and the water inrush amount is 720 m³/h (point I3). There are 10 known observation wells (#1 to #10) for water level changes in the study area. During the TOUGHREACT numerical computation, the whole area in the model is dissected into 80×80 discrete grids. Among them, the middle 3000 m×3000 m range is encrypted and dissected using a 60×60 grid. It is assumed that there are three the permeability parameter subareas in the model. According to the scenario of water inrush, there are six parameters to be identified, which are the horizontal coordinate X of the water inrush points, the vertical coordinate Y of the water inrush points, the water inrush quantity Q, and the permeability of the three subareas (k₁, k₂, and k₃). In this case, k₁, k₂, and k₃ correspond to the other model parameters except X, Y and Q, and correspond to p₁-p₃ in S1. The specific information of the above specific model is shown in FIG. 2.

In order to test the feasibility of the present disclosure, the water level change data of 10 observation wells once every two months are obtained after 2 years of simulating, and the observation noise perturbation obeying the Gaussian distribution N(1, 0.01) is added to the water level change data as the real observation data of water level situation obtained from this hypothetical case. Then based on these observation data information, inverse identification is carried out on the six unknown model parameters such as the locations of the water inrush points.

The range of values of the a priori intervals for these six parameters introduced in S1 is shown in Table 1.

The number of samples in the training sample dataset and test sample dataset in S2 are 300 and 50, respectively.

The indexes of prediction accuracy of the alternative model in S4: the loss function and R² value are 0.0066 and 0.9918, respectively. In order to further improve the prediction accuracy of the alternative model, the number of the training sample dataset is increased to 500 by returning to S2. The alternative model is re-trained, and then the loss function and the R² value are increased to 0.0040 and 0.9968, respectively. At this point, the prediction accuracy already satisfied the requirements and the subsequent steps are performed.

The key parameters during the implementation of the simulated annealing algorithm in S5 are set as follows:
in S501, T₀=100;
in S504 and S505, temperature decay constant α=0.99;
in S505, the number of inner loop is 150;
in S506, the number of outer loop is 300.

The inverse identification results of the six identification parameters obtained by the present disclosure and relative errors between the inverse identification results and the true values are shown in Table 1.

TABLE 1
True values, priori intervals, identification values of inverse
and relative errors of the parameters to be inverted

| | | | Identification | |
|---|---|---|---|---|
| Name of | True | | values of | Relative |
| parameter | values | Priori intervals | inverse | error |
| X | 5625 | [4875, 5725] | 5604.44 | 0.00366 |
| Y | 4975 | [4875, 5025] | 4966.11 | 0.00179 |
| Q(m³/h) | 720 | [360, 1800] | 734.436 | 0.02005 |
| k₁(m²) | 2.891E−14 | [1E−14, 9E−14] | 3.033E−14 | 0.049118 |
| k₂(m²) | 5.097E−13 | [5E−14, 9E−13] | 6.599E−13 | 0.294683 |
| k₃(m²) | 1.044E−13 | [5E−14, 9E−13] | 1.030E−13 | 0.01341 |

From the table, it may be seen that the relative errors of X and Y coordinates of the locations of the water inrush points are within 0.04. The error range of X coordinate is reduced from the original 850 m (4875 m−5725 m) to about 20 m (5625 m−5604.44 m); the error range of Y coordinate is reduced from the original 150 m (4875 m−5025 m) to within 10 m (4975 m−4966.11 m).

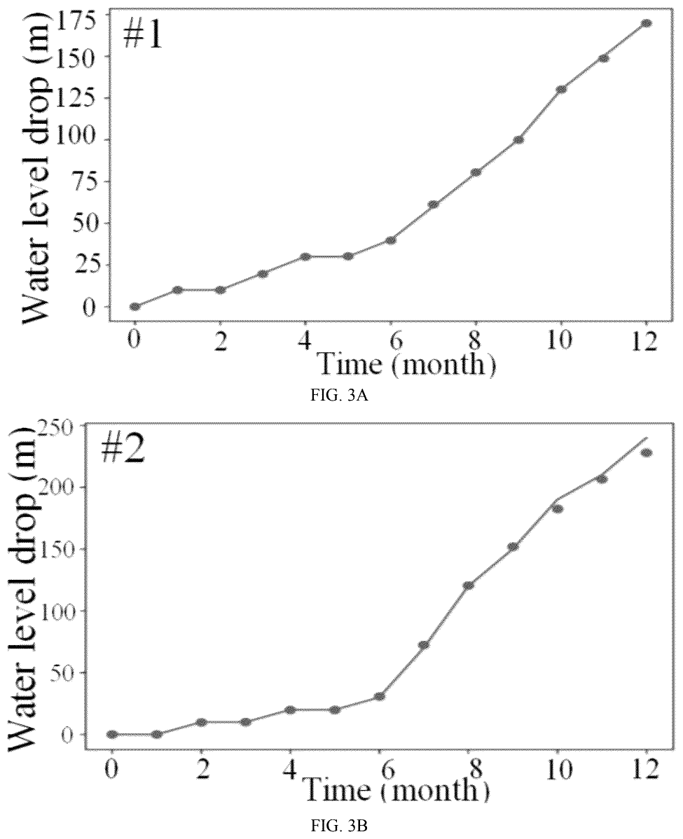

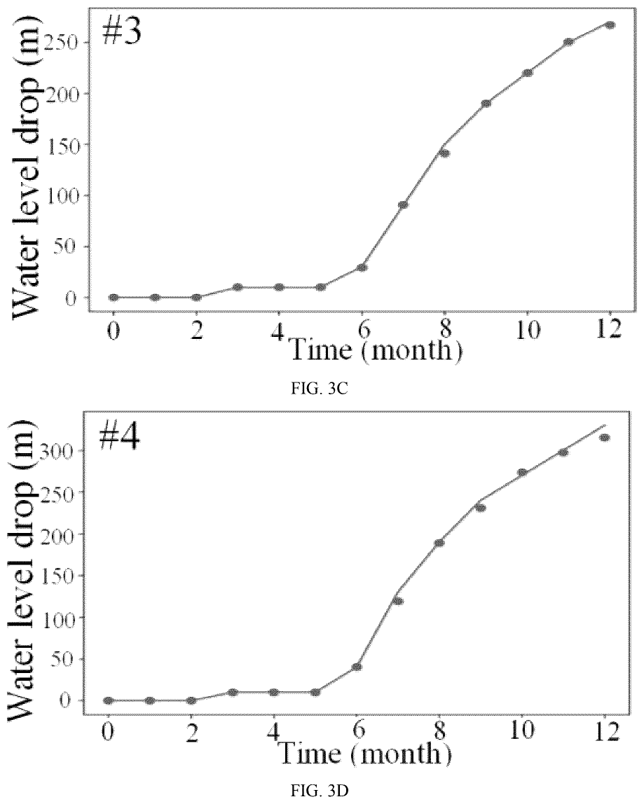

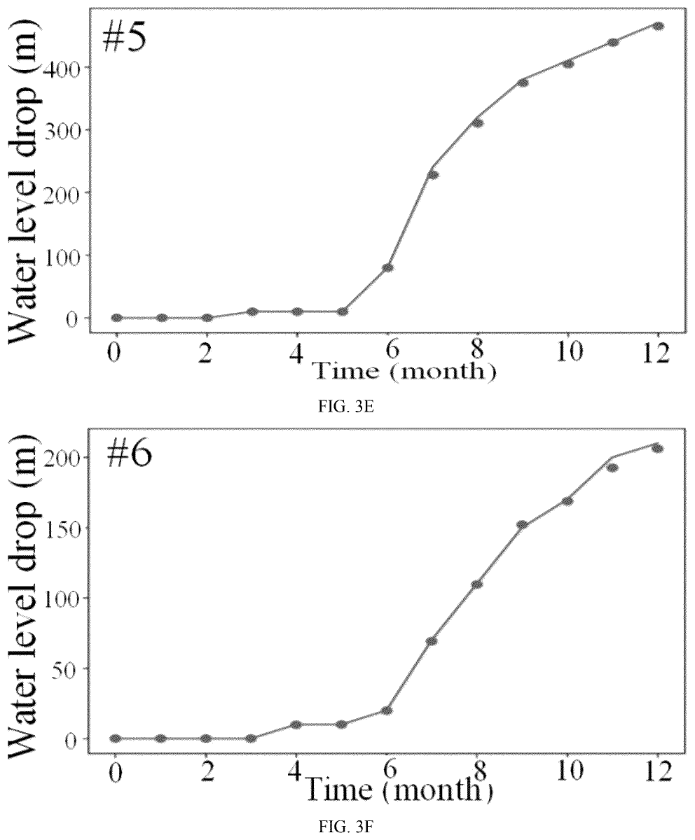

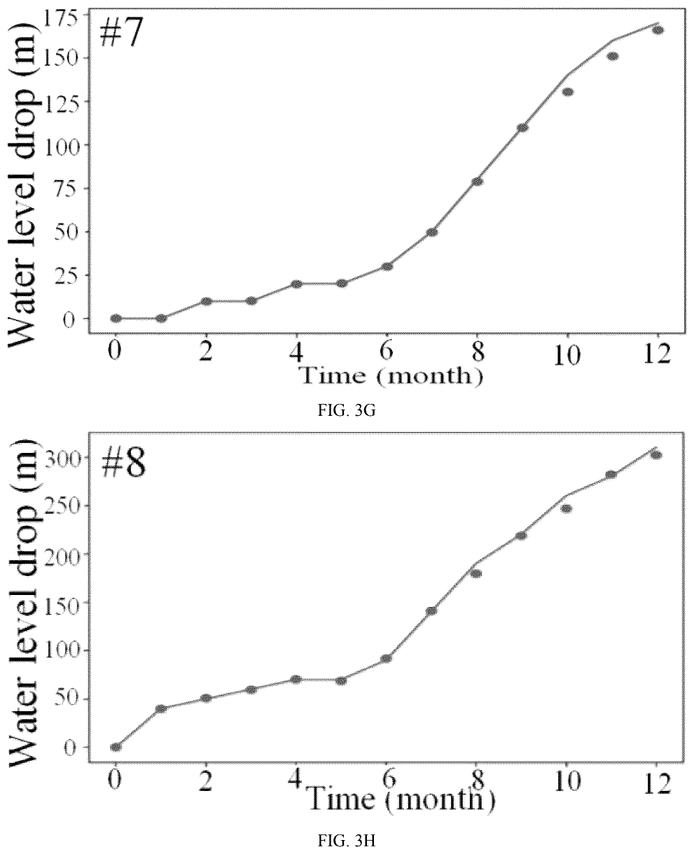

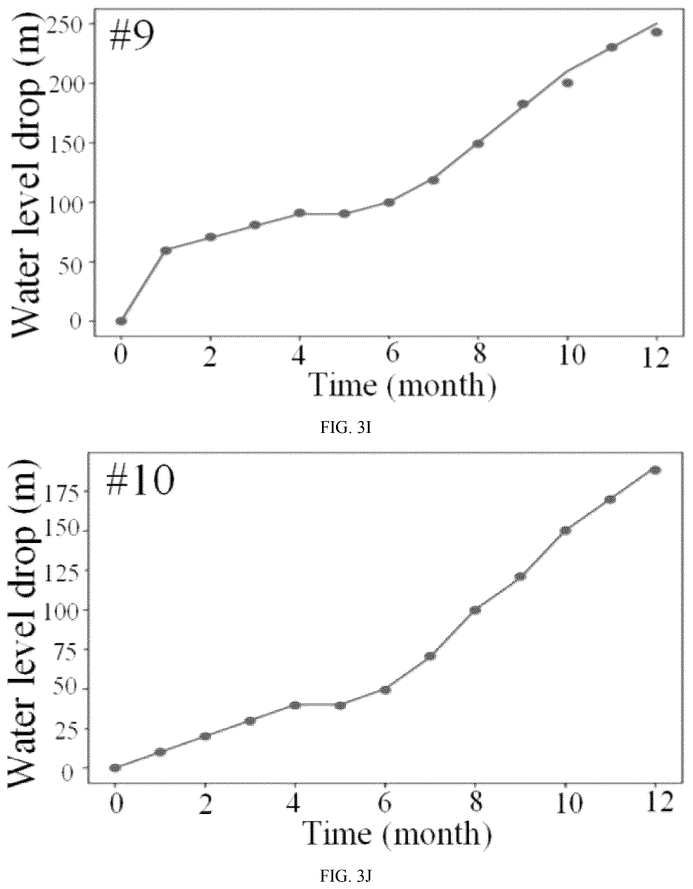

In addition, the relative errors of the other model parameters are within 0.05, except for the k₂ identification result, which has a slightly larger relative error (0.295). Nevertheless, the inverse value of k₂, 6.599×10⁻¹³ m², is in the same order of magnitude as the actual value of 5.097×10⁻¹³ m². FIG. 3A-FIG. 3J shows the comparison between the simulated results of water level difference of correction model and the actual observation results, and correspond to the information of the observation wells #1 to #10 in FIG. 2 (the points in the FIG. 3A-FIG. 3J indicate the actual observation data, and the lines indicate the simulation curves of the model after correction), and as can be seen from the fitting between the simulation results of the correction model and the observation values in FIG. 3A-FIG. 3J may be seen that the observation data of 10 observation wells for two years basically fit the simulation curves after correction. As can be seen from the fitting between the simulation results of the correction model and the observation values in FIG. 3A-FIG. 3J. Combining the above information, the values of Q, k₁, k₂ and k₃ obtained by the inversion solution are all closer to their real values, and a good fitting correction to the numerical model has been realized, and inverse results are also reliable.

It may be seen that an artificial intelligence-based method for identifying locations of water inrush points in a mine and simulation model parameters provided by this disclosure is capable of determining the specific location coordinates of the water inrush points, may accurately locate the water inrush points in the mine, may identify the water inrush quantity and permeability parameter values synchronously, and further may provide key information for the prevention and control of water inrush disasters.

What is claimed is:

1. An artificial intelligence-based method for enhancing mine safety by identifying and predicting locations of water inrush points in a mine, comprising the following steps:
S1: receiving prior information of the mine, comprising hydrological observation data, geological characteristics, and historical records of water inrush; applying the prior information to construct a numerical groundwater-flow model in an aquifer with water inrush in the mine, wherein hydrological observation wells are used as water level observation points to determine the water level changes; preliminarily determining the range of coordinates for water inrush points, water inrush quantity, and a priori intervals for other unknown parameters based on the mining engineering plan, and setting up water level simulation results to output the water inrush points according to locations of actual hydrological observation wells and observation time in the numerical groundwater-flow model;
using a horizontal coordinate x and a vertical coordinate y of locations of the water inrush points, a water inrush quantity Q and n unknown parameters as decision variables, wherein the decision variables are collectively represented as m=[X, Y, Q, p₁, . . . , pₙ], p₁, . . . , pₙ denote the n unknown parameters in the numerical groundwater-flow model, comprising permeability parameters of different subareas and boundary condition parameters; determining a range of values of each of the decision variables in m based on collected prior information, and defining an upper limit and a lower limit of the values of the decision variables as m_{U}=[X_{U}, Y_{U}, Q_{U}, p_{1U}, . . . , p_{nU}] and m_{L}=[X_{L}, Y_{L}, Q_{L}, p_{1L}, . . . , p_{nL}], respectively;
S2: randomly sampling the numerical groundwater-flow model using a Latin hypercube sampling method to generate two sets of the parameter datasets as input parameters of a training sample dataset M_{Train}=[m_{Train(1)}, . . . , m_{Train(n}_{_{Train}}₎] and input parameters of a test sample dataset M_{Test}=[m_{Test(1)}, . . . , m_{Test(n}_{_{Test}}₎], wherein n_{Train} denotes samples of the training sample dataset M_{Train} and n_{Test} denotes the samples of the test sample dataset M_{Test};
calculating water level simulation results for the hydrological observation wells corresponding to each of the samples of the model parameter in M_{Train} and M_{Test} by using the numerical groundwater-flow model, storing all observation data in a vector data format yᵢ, and finally obtaining model response results Y_{Train}=[yₜᵣₐᵢₙ₍₁₎, . . . , y_{Train(n}_{_{Train}}₎] for the training sample dataset and model response results Y_{Test}=[y_{Test(1)}, . . . , y_{Test(n}_{_{Test}}₎] for the test sample dataset, wherein the training sample dataset and the test sample dataset are represented as D_{Train}={M_{Train}, Y_{Train}} and D_{Test}={M_{Test}, Y_{Test}}, respectively;
S3: constructing and training a deep convolutional neural network (DNN model), wherein an input layer and an output layer of the DNN model are a parameter vector mᵢ of the numerical groundwater-flow model and a model response vector yᵢ, respectively; representing the DNN model as ŷᵢ=F_{DNN}(mᵢ,θ_{DNN}), wherein θ_{DNN} denotes a weight parameter of a deep neural network; constructing a deep convolutional neural network based on constraints of L1 norm to realize a loss function of an alternative model prediction of the numerical groundwater-flow model, and then with a target of minimizing the loss function, updating θ_{DNN} by using an error back-propagation algorithm to complete training of the DNN model and then to obtain a trained DNN model; and using the trained DNN model F_{DNN}(mᵢ,θ_{DNN}) as an alternative model to the numerical groundwater-flow model in S1;
S4: substituting the input parameters M_{Test} from the test sample dataset D_{Test} into the trained DNN to obtain corresponding prediction results Ŷ_{Test}=[ŷ_{Test(1)}, . . . , ŷ_{Test(n}_{_{Test}}₎]; comparing whether a prediction accuracy of the alternative model meets requirements based on values of the converged loss function L trained by F_{DNN} (mᵢ,θ_{DNN}) and values of a calculating a certainty coefficient R² and evaluating prediction accuracy by comparing predicted results Y_{Test} and Ŷ_{Test}; performing S5, if the prediction accuracy meets the requirements; otherwise, returning to S2 to increase the number of samples of the training sample dataset and retraining the DNN; and
S5: solving a nonlinear optimization inversion model using the trained DNN model F_{DNN} (mᵢ,θ_{DNN}) that meets the accuracy requirements in S4 as an equation constraint, using the upper limit m_{U} and lower limit m_{L} in the overall of the decision variables m in S1 as inequality constraints, and combining with least squares constraints to construct a nonlinear optimization inversion model used as constraints of the overall of the decision variables m=[X, Y, Q, p₁, . . . , pₙ] in S1; and then optimally solving the overall of the decision variables m by using a simulated annealing algorithm to find an optimal solution of the overall of decision variables m under the constraints of the nonlinear optimization inversion model constructed in this step to obtain the coordinate X and the coordinate Y of the locations of the water inrush points and the other parameters Q and p₁, . . . , pₙ for simulation prediction.

2. The artificial intelligence-based method according to claim 1, wherein in S1, the numerical groundwater-flow model in the aquifer with water inrush in the mine is constructed by using a numerical groundwater-flow simulation software TOUGHREACT.

3. The artificial intelligence-based method according to claim 1, wherein according to the upper limit m_{U} and the lower limit m_{L} of the decision variables in S1, the Latin hypercube sampling method is used to sample in S2, and follows a principle of uniformly distributed sampling;
the number of samples n_{Train} is greater than a number of the samples n_{Test}, and the number of the samples n_{Test} greater than or equal to 50.

4. The artificial intelligence-based method according to claim 1, wherein a deep residual two-dimensional convolutional neural network of the ResNet-18 is improved to obtain the DNN model in S3, comprising:
firstly mapping and outputting vector data input to the decision variables as a 6400-dimensional vector by using a fully connected neural network, and then reshaping the 6400-dimensional vector as an 80×80 rectangular data structure used as the input layer of the ResNet-18, wherein the output layer is a vector with a dimension consistent with observation data y.

5. The artificial intelligence-based method according to claim 1, wherein in S3, a calculation formula for constructing the deep convolutional neural network based on the constraints of the L1 norm to realize the loss function of the alternative model prediction is as follows:
$${θ}_{DNN} = arg min \frac{1}{N} {\sum }_{i = 1}^{N} \vert {F}_{DNN} ( {m}_{i} , {θ}_{DNN} ) - {y}_{i} \vert + \frac{{w}_{d}}{2} {θ}_{DNN}^{T} {θ}_{DNN} , \qquad ( 1 )$$
wherein θ_{DNN} denotes a weight parameter of the deep neural network; mᵢ and yᵢ denote a model parameter and model output of i-th group of the samples in the training sample dataset, respectively; N denotes a total number of the samples in the training sample dataset; and w_{d} denotes a regularization term during the training of neural network, and is used to prevent the training from overfitting.

6. The artificial intelligence-based method according to claim 5, wherein in S3, θ_{DNN} is updated with the target of minimizing the loss function in formula (1) by using a deep learning framework pytorch.

7. The artificial intelligence-based method according to claim 1, wherein in S4, a formula for calculating the certainty coefficient R² is as follows:
$${R}^{2} = 1 - \frac{{\sum }_{i = 1}^{M} {‖ {y}_{Test ( i )} - {\hat{y}}_{Test ( i )} ‖}_{2}^{2}}{{\sum }_{i = 1}^{M} {‖ {y}_{Test ( i )} - \overline{y} ‖}_{2}^{2}} , \qquad ( 2 )$$
wherein y̅ denotes a mean of all y_{Train(i)}.

8. The artificial intelligence-based method according to claim 7, wherein in S4, the smaller the values of the converged loss function L is and the closer the values of the certainty coefficient R² is to 1, the higher the prediction accuracy of the alternative model F_{DNN} (mᵢ,θ_{DNN}) is; a threshold of the loss function L₀ and a threshold of the certainty coefficient R₀² is set in advance; and then it is determined if the prediction accuracy of the alternative model satisfies the accuracy requirements by judging whether L is less than or equal to L₀ and R² is greater than or equal to R₀².

9. The artificial intelligence-based method according to claim 1, wherein in S5, a basic form of the nonlinear optimization inversion model is as follows:
$$\begin{matrix}F = min {\sum }_{i = 1}^{{N}_{obs}} {[ {y}_{obs} [ i ] - \hat{y} [ i ] ]}^{2} \\ \{ \begin{matrix}\hat{y} = {F}_{DNN} ( {m}_{i} , {θ}_{DNN} ) \\ {m}_{U} \leq m \leq {m}_{L}\end{matrix}\end{matrix} , \qquad ( 3 )$$
wherein F denotes an objective function based on the least squares constraint; y_{obs} denotes a vector of the observation data; y_{obs}[i] denotes i-th variable element in the vector of the observation data; m_{L} and m_{U} denote the upper limit vector and lower limit vector of the model parameter vector m, respectively; and N_{obs} denotes a number of the observation data.

10. The artificial intelligence-based method according to claim 9, wherein in S5, the simulated annealing algorithm is performed in the following steps:
S501: setting a hyperparameter initial iteration temperature T₀ of the simulated annealing algorithm and an initial solution mᵢ of the decision variables m;
S502: generating a new solution mⱼ randomly in neighborhood of mᵢ by multiplying mᵢ by a random disturbance coefficient e(mⱼ=e*mᵢ), wherein e is a random number of dimension consistent with m randomly generated according to a Gaussian distribution N˜(1,σ²), wherein σ takes a value of 0.01 by default, and the value of σ may be adjusted in different application scenarios with an adjustment range of 0-0.1;
S503: calculating mᵢ and mⱼ by substituting into formula (3), respectively, to obtain values of an inverse optimization objective function corresponding to mᵢ and mⱼ: Fᵢ and Fⱼ;
S504: updating a current solution mᵢ to mⱼ, if Fᵢ is greater than or equal to Fⱼ; otherwise, calculating a probability of updating mᵢ to mⱼ according to a following formula:
$$P ( {m}_{i} →︀ {m}_{j} = exp ( \frac{{F}_{i} - {F}_{j}}{{a}^{t} {T}_{0}} ) , \qquad ( 4 )$$
where α denotes an attenuation coefficient in the simulated annealing algorithm, and takes a value of 0.99; t denotes current time, and indicates the current number of loop iterations; T₀ denotes a temperature at moment of initial iteration, and takes a value of 100 by default; the probability in formula (4) is judged by generating a random number rand(x) between 0 and 1, and when rand(x) is less than or equal to P(mᵢ→mⱼ), then mᵢ is updated to mⱼ; otherwise, mᵢ is not updated;
S505: repeating S502 to S504 under current temperature conditions until a preset number of inner loop iterations in the simulated annealing algorithm is reached; then updating the temperature and the time: t=t+1 and Tₜ=α′T₀, respectively;
S506: returning S502 and updating Tt and t obtained in S505 until a preset number of the outer loop iterations is reached.
